(19) United States
(12) Patent Application Publication
(10) Pub. No.: US 2007/0019266 A1
(43) Pub. Date: Jan. 25, 2007

(54) Holographic stereogram creation device and its method

(75) Inventors: Nobuhiro Kihara, Kanagawa (JP); Akira Shirakura, Tokyo (JP); Shigeyuki Baba, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/485,312

(22) Filed: Jul. 13, 2006

(30) Foreign Application Priority Data
Jul. 20, 2005 (JP) 2005-209579

(51) Int. Cl. G03H 1/26

(52) U.S. Cl. 359/23

(57) ABSTRACT

In a holographic stereogram creating device for creating a holographic stereogram by sequentially recording interference fringes between reference light and object light, which is obtained by sequentially spatial-modulating a plurality of images picked up from different observing points, as strip or dot elemental holograms, on one hologram recording material of an object light projection optical system for irradiating the hologram recording material with the spatially modulated object light, the object light projection optical system includes a slit arranged at a conjugate position of the hologram recording material for eliminating unnecessary light and a lens attached to the slit.

### CROSS REFERENCES TO RELATED APPLICATIONS

The present invention contains subject matter related to Japanese Patent Application JP 2005-209579 filed in the Japanese Patent Office on Jul. 20, 2005, the entire contents of which are incorporated herein by reference.

### BACKGROUND OF THE INVENTION

1. Field of the Invention

The present invention relates to a holographic stereogram creation device for creating a holographic stereogram capable of three-dimensionally recognizing images and its method, and in particular it relates to the reduction of blur in a depth wise direction.

2. Description of the Related Art

A holographic stereogram is created by sequentially recording a number of original pictures, which are obtained by sequentially picking up an object from different observing points, on one holographic recording medium as strip or dot elemental holograms. For example, in a holographic stereogram having parallax information only in the horizontal direction, a plurality of original pictures, obtained by sequentially picking up an object from different observing points in the horizontal direction, are sequentially recorded on the holographic recording medium as strip elemental holograms. When the holographic stereogram is viewed with one eye from a certain point, two-dimensional images are shown, which are aggregate of image information in part of elemental holograms. When the eye position is moved in the horizontal direction, two-dimensional images are shown, which are aggregate of image information in different part of elemental holograms. Hence, when an observer views this holographic stereogram with both eyes, as positions of both the eyes are slightly different in the horizontal direction, the two-dimensional images viewed by the respective eyes are slightly different from each other. Thereby, the observer feels parallax so as to recognize the images as three-dimensional images.

When creating the holographic stereogram, each elemental hologram is formed by dividing an interfering laser light source into two, one as projection images (object light) modulated into two-dimensional images by image displaying means (a liquid crystal panel, for example) and the other as reference images, so as to be concentrated on a hologram recording material made of a photosensitive material for recording interference fringes as changes in refractive index of the photosensitive material.

At this time, in a reflection hologram, for corresponding to the observing point movement in a longitudinal direction (non-parallax direction) (for securing an angle of field in a non-parallax direction), a diffused plate (diffused plate of one dimension) may be provided in the foreground of a hologram recording material (see U.S. Pat. No. 6,330,088 B1, P10, FIG. 9).

FIG. 5 is a block diagram of an object light projection optical system of the conventional holographic stereogram creating device mentioned above. The object light projection optical system is composed of a lens 21, a slit 22, a lens 23, and a lens 24, and it condenses object light modulated by a spatial light modulator (SLM) 25 on a hologram recording material 50. At this time, part other than the elemental holograms is prevented from being exposed on the hologram recording material 50 by cutting higher-order light generated from the SLM 25 with the slit 22.

FIG. 6 is a block diagram of an object light projection optical system of a conventional holographic stereogram having only horizontal parallax. The structure of this object light projection optical system is similar to that shown in FIG. 5; however, an object lens 26 is cylindrical. Thus, in a non-parallax direction shown in the upper row of the drawing, object light simply transmits through the cylindrical lens 26 while in a parallax direction shown in the lower row of the drawing, the object light is converged on the hologram recording material 50 by the cylindrical lens 26 acting as a convex lens. At this time, part other than the elemental holograms is prevented from being exposed on the hologram recording material 50 by cutting higher-order light generated from the SLM 25 with the slit 22.

However, in the object light projection optical system of the conventional holographic stereogram shown in FIG. 5, when light emitted from one point of the SLM 25 does not become parallel light on the hologram, blur is generated in a depth wise direction. Also, in the object light projection optical system of the conventional HPO (horizontal parallax only) stereogram shown in FIG. 6, the parallel light on the elemental hologram is not intentionally designed in the parallax direction, so that when light emitted from one point of the SLM 25 does not become parallel light on the hologram, blur is generated in the depth wise direction. Then, in order to reduce the blur in the depth wise direction, as shown in FIG. 7, there is provided a method in that a convex lens 28 is arranged in close vicinity to the hologram recording material 50 (see U.S. Pat. No. 6,330,088 B1, P10, FIG. 9).

### SUMMARY OF THE INVENTION

However, when the convex lens 28 is arranged in close vicinity to the hologram recording material 50 for reducing the blur in the depth wise direction as mentioned above, both the convex lens 28 and the hologram recording material 50 may come in contact with each other because their vicinity, causing damage to the convex lens 28 and the hologram recording material 50.

The present invention has been made in view of the situation mentioned above, and it is desirable to provide a holographic stereogram creation device and its method capable of reducing blur in the depth wise direction of a holographic stereogram without causing damage to optical elements and a hologram recording material.

For the purpose mentioned above, in a holographic stereogram creating device for creating a holographic stereogram by sequentially recording interference fringes between reference light and object light, which is obtained by sequentially spatial-modulating a plurality of images picked up from different observing points, as strip or dot elemental holograms, on one hologram recording material of an object light projection optical system for irradiating the hologram recording material with the spatially modulated object light, the holographic stereogram creating device includes a slit arranged at a conjugate position of the hologram recording material for eliminating unnecessary light and a lens attached to the slit.

In such a manner, according to the present invention, attaching a convex lens to the unnecessary light removing slit arranged at a conjugate position of the hologram recording material of the object light projection optical system (conjugate position of the elemental hologram) is equivalent in function to attaching the convex lens to the hologram recording material, so that light emitted from one point of the spatial light modulator becomes parallel light on the hologram recording material, and the holographic stereogram can be made three-dimensional images being sharply in focus without blur in the depth wise direction.

According to the present invention, by adding a convex lens function to the unnecessary light removing slit arranged at a conjugate position of the hologram recording material of the object light projection optical system for irradiating spatially modulated object light on the hologram recording material and leaving a slit function to the unnecessary light removing slit, the blur in the depth wise direction of the holographic stereogram can be reduced.

Since the slit having a lens function is separated from the hologram recording material, the above-mentioned effect can be achieved without damaging the lens and the hologram recording material.

Furthermore, since the number of optical components arranged adjacent to the hologram recording material can be reduced, the limit in mechanism can be reduced.

### BRIEF DESCRIPTION OF THE DRAWINGS

FIG. 1 is a block diagram of a holographic stereogram creation device according to a first embodiment of the present invention;

FIG. 2 is a block diagram of the object light projection optical system shown in FIG. 1;

FIG. 3 is a drawing illustrating another method for attaching a convex lens to the slit shown in FIG. 1;

FIG. 4 is a block diagram of an essential part of a holographic stereogram creation device according to a second embodiment of the present invention;

FIG. 5 is a block diagram of an example of an object light projection optical system of a conventional holographic stereogram creation device;

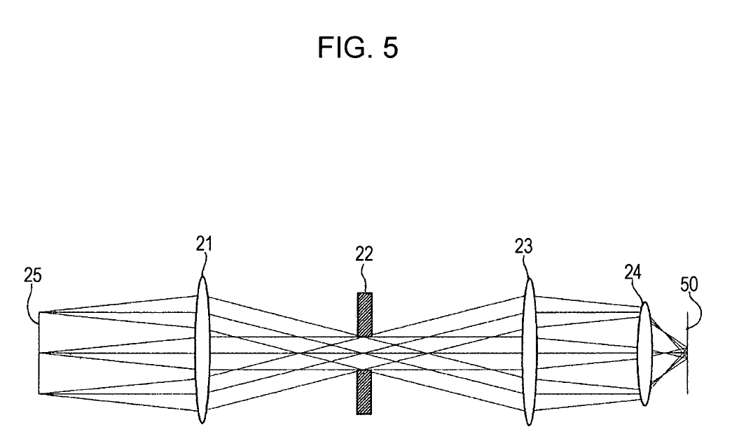

FIG. 6 is a block diagram of an object light projection optical system of a conventional holographic stereogram having only horizontal parallax; and

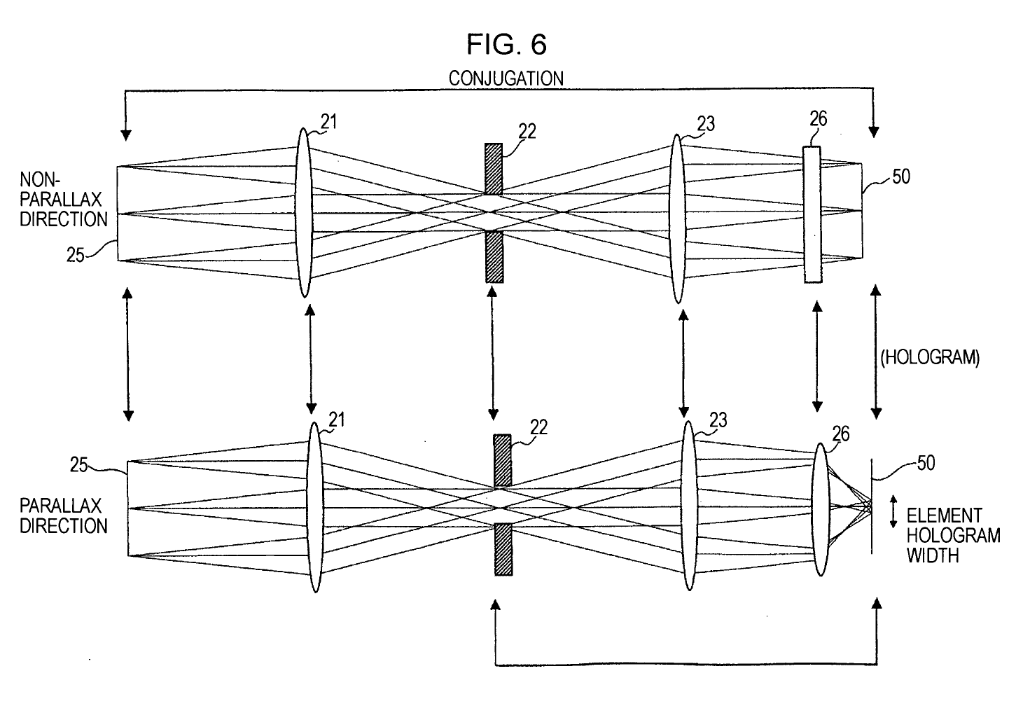

FIG. 7 is a drawing illustrating a conventional method for reducing blur of a holographic stereogram in the depth wise direction.

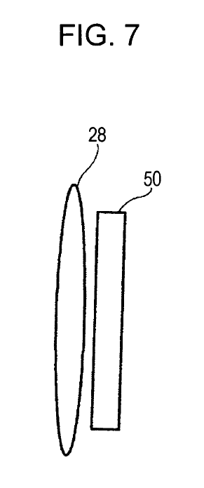

### DESCRIPTION OF THE PREFERRED EMBODIMENTS

In order to reduce blur in the depth wise direction of a holographic stereogram without causing damage to optical elements and a hologram recording material, in an object light projection optical system for irradiating spatially modulated object light on the hologram recording material, to an unnecessary light removing slit arranged at a conjugate position of the hologram recording material, a convex lens function is added, leaving a slit function to the unnecessary light removing slit. Thereby, the blur in the depth wise direction of the holographic stereogram can be reduced without causing damage to the optical elements and the hologram recording material.

### First Embodiment

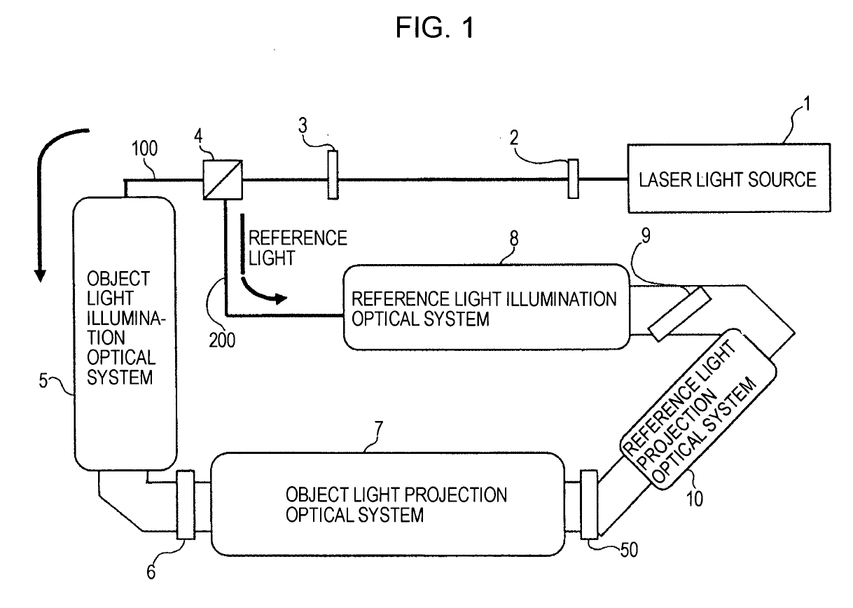

FIG. 1 is a block diagram of a holographic stereogram creating device according to a first embodiment. The holographic stereogram creating device includes a laser light source 1, a shutter 2, a half-wave plate (HWP) 3, a polarization beam splitter (PBS) 4, an object light illumination optical system 5, a spatial light modulator (SLM) 6, an object light projection optical system 7, a hologram recording material 50, a reference light illumination optical system 8, a reference light slit 9, and a reference light projection optical system 10.

Then, the operation of the first embodiment will be described. Laser light emitted from the laser light source 1 enters the PBS 4 so as to be split into an object light 100 and a reference light 200 after it passed through the HWP 3 to be modulated in polarizing direction. The object light 100 enters the spatial light modulator 6 via the object light illumination optical system 5 so as to be modulated in intensity by displayed images. Then, the hologram recording material 50 is irradiated with the object light 100 via the object light projection optical system 7. On the other hand, the hologram recording material 50 is irradiated with the reference light 200 via the reference light illumination optical system 8, the reference light slit 9, and the reference light projection optical system 10. Thereby, interference fringes between the object light 100 and the reference light 200 are formed on the hologram recording material 50. At this time, on the spatial light modulator 6, by displaying a plurality of original pictures obtained by sequentially picking up an object from different observing points in a horizontal direction, strip elemental holograms are sequentially recorded on the hologram recording material 50.

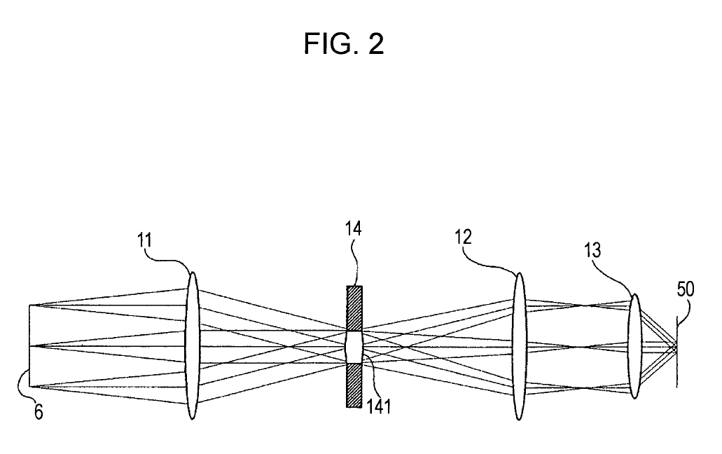

FIG. 2 is a block diagram of the object light projection optical system 7 shown in FIG. 1. The object light projection optical system 7 includes a lens 11, a lens 12, a lens 13, and a slit 14 arranged at a conjugate position of the hologram recording material 50 and having a concave lens 141.

According to the embodiment, providing the convex lens 141 fitted into a slit portion of the slit 14 arranged at a conjugate position of the hologram recording material 50 is equivalent to a case where the convex lens 141 is arranged in close vicinity to the hologram recording material 50. Thereby, light emitted from one point of the spatial light modulator 6 becomes parallel light on the hologram recording material 50, so that the holographic stereogram is prevented from generating blur in the depth wise direction. Moreover, since the convex lens 141 is separated from the hologram recording material 50 and both the members do not come in contact with each other, the convex lens 141 and the hologram recording material 50 are not damaged, improving the reliability of the device.

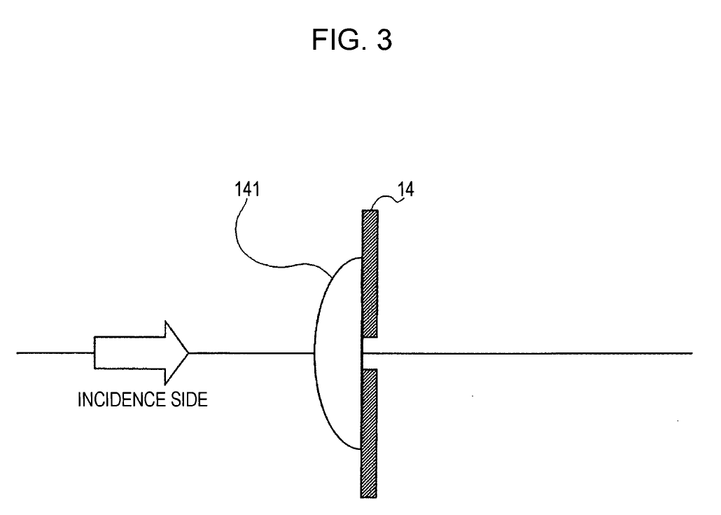

When the convex lens 141 is attached to the slit 14, as shown in FIG. 3, the closely contact of the convex lens 141 to the front face of the slit 14 is equivalent to the closely contact of the convex lens 141 to the recording surface of the hologram recording material 50, so that the holographic stereogram can be made three-dimensional images being sharply in focus in the depth wise direction.

### Second Embodiment

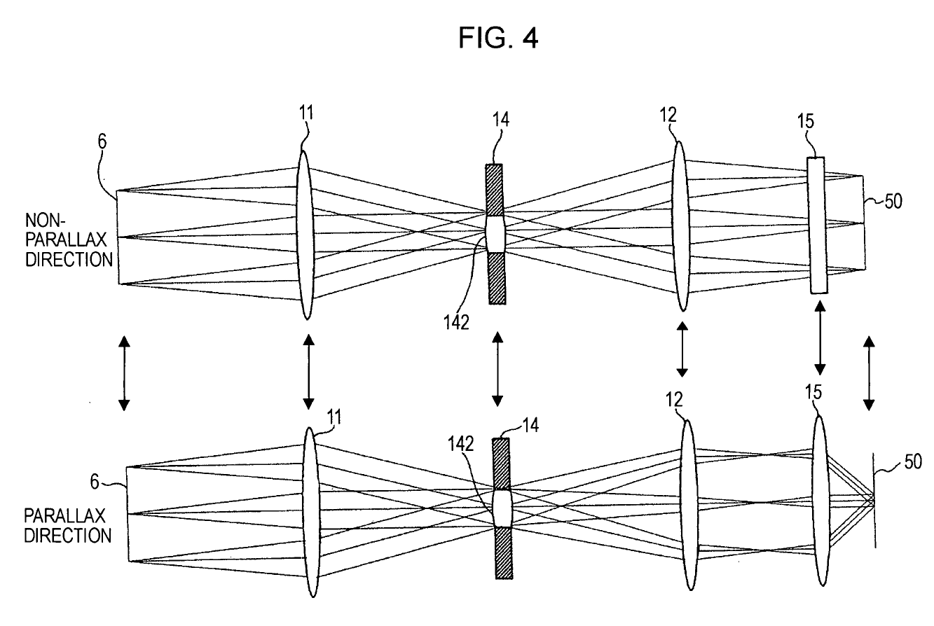

FIG. 4 is a block diagram of an essential part of a holographic stereogram creating device according to a second embodiment of the present invention. This is an example of an object light projection optical system of an HPO stereogram having a structure similar to that of the first embodiment. The different points include that the convex lens of the hologram recording material 50 is a cylindrical lens 15, and a cylindrical lens 142 is fitted into a slit portion of the slit 14. Thus, in a non-parallax direction shown in the upper row of the drawing, object light simply transmits through the cylindrical lens 142 and the cylindrical lens 15 while in a parallax direction shown in the lower row of the drawing, these cylindrical lenses act as convex lenses, so that light emitted from one point of the spatial light modulator 6 becomes parallel light on the hologram recording material 50, and the hologram recording material 50 is irradiated with the light.

According to the embodiment, in the parallax direction, by the cylindrical lens 142 fitted into a slit portion of the slit 14 arranged at a conjugate position of the hologram recording material 50, light emitted from one point of the spatial light modulator 6 becomes parallel light on the hologram recording material 50, so that the blur of the holographic stereogram recorded on the hologram recording material 50 can be eliminated in the depth wise direction.

Also, according to the embodiment, in the same way as in FIG. 3, by attaching the cylindrical lens to the slit, the holographic stereogram can be made three-dimensional images being sharply in focus in the depth wise direction.

It should be understood by those skilled in the art that various modifications, combinations, sub-combinations and alterations may occur depending on design requirements and other factors insofar as they are within the scope of the appended claims or the equivalents thereof.

What is claimed is:

1. A holographic stereogram creating device for creating a holographic stereogram by sequentially recording interference fringes between reference light and object light, which is obtained by sequentially spatial-modulating a plurality of images picked up from different observing points, on one hologram recording material as strip or dot elemental holograms, the holographic stereogram creating device comprising:
a slit arranged at a conjugate position of the hologram recording material of an object light projection optical system for irradiating the hologram recording material with the spatially modulated object light for eliminating unnecessary light; and
a lens attached to the slit.

2. The device according to claim 1, wherein the holographic stereogram includes only a horizontal parallax.

3. The device according to claim 1 or 2, wherein the plurality of images are obtained by sequentially picking up an object from different observing points.

4. The device according to claim 1 or 2, wherein the lens is fitted into the slit.

5. The device according to claim 1 or 2, wherein the lens adheres on the front face of the slit so as to cover the slit.

6. The device according to any one of claims 1 to 5, wherein the lens is a convex lens or a cylindrical lens.

7. A holographic stereogram creating method for creating a holographic stereogram by sequentially recording interference fringes between reference light and object light, which is obtained by sequentially spatial-modulating a plurality of images picked up from different observing points, on one hologram recording material as strip or dot elemental holograms, the method comprising the steps of:
arranging an unnecessary light removing slit at a conjugate position of the hologram recording material of an object light projection optical system for irradiating the hologram recording material with the spatially modulated object light; and
adding a convex lens function to this slit and leaving a slit function to the unnecessary light removing slit.
